(19) United States
(12) Patent Application Publication
(10) Pub. No.: US 2007/0099593 A1
(43) Pub. Date: May 3, 2007

(54) Method for managing interchangeable accessory modules connected to a portable communication device

(76) Inventors: Timothy Thome, Spring Valley, CA (US); Yasser A. Ansari, Mission Viejo, CA (US); Kyle Halkola, San Diego, CA (US)

Correspondence Address: KYOCERA WIRELESS CORP., P.O. BOX 928289, SAN DIEGO, CA, 92192-8289, US

(21) Appl. No.: 11/264,888

(22) Filed: Nov. 2, 2005

(51) Int. Cl. H04B 1/08; H04M 1/00

(52) U.S. Cl. 455/349; 455/556.1

(57) ABSTRACT

A portable communication device and system in accordance with the exemplary embodiment comprises interchangeable accessory modules allowing different accessory devices to be used with a portable communication device assembly. The accessory modules and the portable communication device assembly form portable communication devices when the accessory modules are secured to the portable communication device assembly. The accessory devices may include sensing devices, music players, displays, GPS receivers, user interfaces, cameras, memory devices, as well as others devices. The portable communication device manages and controls the interchangeable accessory modules by exchanging data and control signals through a connection interface.

### RELATED APPLICATIONS

This application is related U.S. patent application Ser. No. XX/XXX,XXX entitled “PORTABLE COMMUNICATION DEVICE AND SYSTEM WITH INTERCHANGEABLE ACCESSORY MODULES” filed concurrently with this application on Nov. 2, 2005 and incorporated by reference herein.

### FIELD OF THE INVENTION

The invention relates in general to portable communication devices and more specifically to a method for managing interchangeable accessory modules when connected to a portable communication device.

### BACKGROUND OF THE INVENTION

Portable communication devices such as cellular telephones are increasingly including built-in accessories to perform a variety of functions in addition to communication tasks. For example, many portable communication devices include digital cameras, video cameras, sound recorders, music players, large color displays, and Bluetooth interface devices.

Conventional portable communication devices are limited in that the accessories are permanently mounted within the portable communication device. Conventional portable communication devices are bigger and more complex than required for many applications since unneeded devices or software is included in the portable communication device. For example, some users may not use a camera although a camera is mounted within the housing of the portable communication device. The resulting portable communication device is larger, heavier, and more expensive than required for situations where a camera is not needed. In addition, manufacturing costs are increased when several models of a portable communication device are manufactured to include different accessories. Conventional devices are further limited that modifications to include a particular accessory for a relatively small number units is not cost efficient since new industrial and functional designs may be required to include the accessory.

Accordingly, there is a need for a method for managing interchangeable accessory modules when connected to a portable communication device.

### BRIEF DESCRIPTION OF THE DRAWINGS

FIG. 1 is a block diagram of an exploded side view of a portable communication device in accordance with the exemplary embodiment of the invention.

FIG. 2 is a block diagram of a side view of the accessory module connected to the portable device assembly in accordance with the exemplary embodiment of the invention.

FIG. 3 is an illustration of a perspective view of a portable device assembly in accordance with the exemplary embodiment of the invention.

FIG. 4 is an illustration of a perspective view of the accessory module in accordance with the exemplary embodiment of the invention.

FIG. 5 is a block diagram of a accessory interface application in accordance with the exemplary embodiment of the invention.

FIG. 6 is a block diagram of communication frame platform in accordance with the exemplary embodiment of the invention.

FIG. 7 is a block diagram of the accessory module where the accessory device includes a sensor in accordance with the exemplary embodiment of the invention.

FIG. 8 is a block diagram of the accessory module where the accessory device includes a music player in accordance with the exemplary embodiment of the invention.

FIG. 9 is a block diagram of the accessory module where the accessory device includes global positioning satellite (GPS) receiver in accordance with the exemplary embodiment of the invention.

FIG. 10 is a block diagram of the accessory module where the accessory device includes a user interface in accordance with the exemplary embodiment of the invention.

FIG. 11 is a block diagram of the accessory module where the accessory device includes a memory drive interface in accordance with the exemplary embodiment of the invention.

FIG. 12 is a flow chart of a method for managing the accessory module performed in the portable device assembly in accordance with the exemplary embodiment.

FIG. 13 is flow chart of an exemplary method for performing an initialization procedure.

### SUMMARY OF THE INVENTION

In one embodiment, a method performed at a portable device assembly includes receiving data from an accessory module detachably connected to the portable device assembly and including an accessory device and a battery for providing power to portable communication device formed when the accessory module is connected to the portable device assembly. Data packets including the data are received through an interface connection between the accessory module and portable device assembly.

### DETAILED DESCRIPTION

A portable communication device and system in accordance with the exemplary embodiment comprises user interchangeable accessory modules allowing different accessories to be used with a portable communication device assembly. Each of the accessory modules forms a portable communication device when secured to the portable communication device assembly. In the exemplary embodiment, the accessory modules comprise a battery, an accessory device, and a module interface configured to connect the accessory device to device circuitry in the portable communication device assembly. Functionality of the portable communication device is expanded by connecting an accessory module. Accordingly, numerous accessory modules may be used with a single portable communication device assembly to form portable communication devices with different capabilities. Since the accessory module is implemented within a battery module in the exemplary embodiment, functionality of the portable communication device is changed by interchanging battery modules. The exemplary method facilitates management and control of the interchangeable accessory modules by exchanging control and data signals through a connection interface.

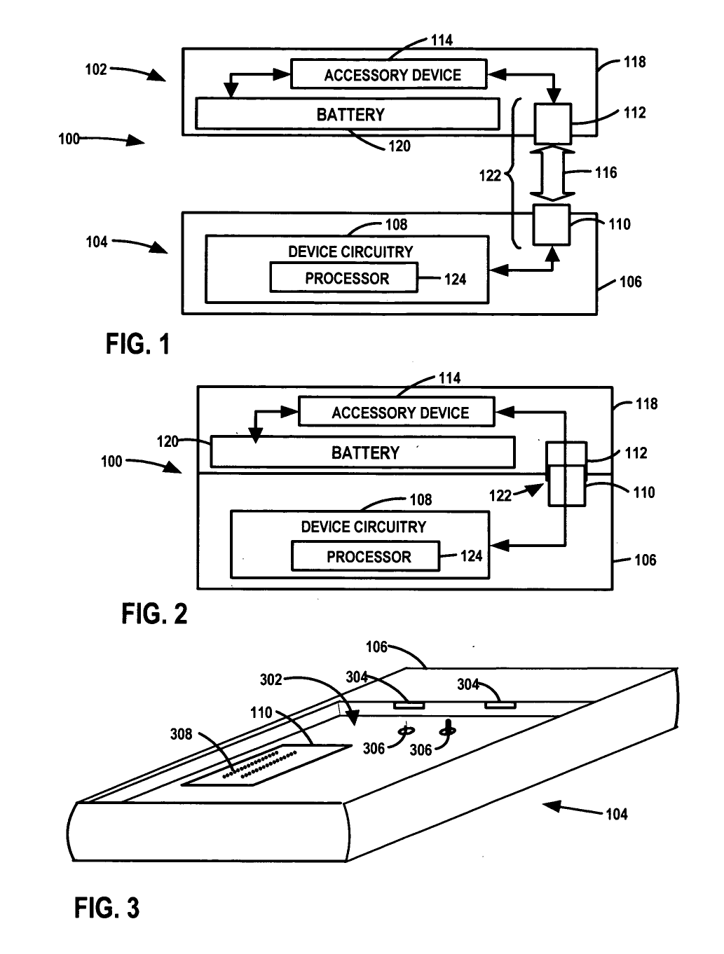

FIG. 1 and FIG. 2 are block diagrams of side views of a portable communication device 100 in accordance with the exemplary embodiment of the invention where FIG. 1 is an exploded side view and FIG. 2 is a side view of the accessory module 102 connected to the portable device assembly 104. The blocks in FIG. 1 and FIG. 2 generally represent exemplary relative configurations of the portable device assembly 104 and the accessory module 102 and do not necessarily represent all relative sizes or positions of the components illustrated. The device assembly 104 and each accessory module 102 form a portable communication device 100 when the when the accessory module 102 is attached. The functionality of the portable communication device 100 is expanded by attaching a selected accessory module 102. As discussed below in further detail, the accessory modules 102 may include modules with sensors, cameras, integrated circuits (IC), memory devices, music players, and multimedia players as well as any of numerous other electrical and mechanical mechanisms.

The portable device assembly 104 includes electrical and mechanical components that facilitate wireless communication as well as other functions. In the exemplary embodiment, the portable device assembly 104 includes input and output devices such as displays, keypads, buttons, speaker, and a microphone in addition to a plastic housing 106, printed circuit board, antenna, electrical circuitry and other components. The device circuitry 108 includes a processor 124 and radio frequency (RF) communication circuits as well as hardware, software and/or firmware for performing functions other than RF communication. An assembly interface 110 connected to the device circuitry 108 engages a module interface 112 of the accessory module 102 to form one or more electrical connections between device circuitry 108 and an accessory device 114 in accordance with an interface standard 116. The module interface 112 and the assembly interface 110 form a connection interface 122. Any of numerous mechanical and electrical configurations as well as any of numerous physical layer protocol and communication layer protocols may used to implement the module interface 112, assembly interface 110, and interface standard 116. As described below in further detail, a connection pad used for testing and programming the portable communication device is utilized in the exemplary embodiment to form the assembly interface 110. Accordingly, hardware, software and/or firmware utilized for other purposes may be used to form a connection interface in the exemplary embodiment. In some circumstances, the connection interface 122 may be a wireless interface such as a RF, infrared, or Bluetooth connection.

The accessory module 102 includes a module housing 118 that at least partially encloses the accessory device 114. The module housing 118 also functions as battery compartment door in the exemplary embodiment. Although the battery 120 is part of the accessory module 102, the battery 120 may be inserted into the portable device assembly 104 separately from the accessory module 102 in some circumstances. Therefore, in the exemplary embodiment, a user adds or changes an accessory device 114 by selecting and attaching a battery module containing the desired accessory function. For example, a user may replace a standard battery module with a camera battery module when the functionality of a camera phone is desired.

The accessory device 114 includes any combination of hardware, software, and/or firmware for performing an accessory function such as sensing data, accepting user inputs, presenting user outputs, presenting information, storing information or processing information. The accessory device 114 performs functions in addition to standard communication functions performed by the device circuitry 108 of the portable device assembly 104. The accessory device may be a sensing device such as for example, a camera, a temperature sensor, radiation sensor, a movement sensor (such as a gyroscope), airborne particle detector, mold detector, smoke detector, or radio frequency detector. Further, the accessory device may be an electronic device that performs a specified user function such as a music player, a multimedia player, a memory device, or a GPS receiver.

As discussed below in further detail, an accessory interface application running on the processor 122 facilitates the exchange of command, control, and data signals between the portable device assembly 104 and the accessory module 102. The processor 12 is any processor, controller, microprocessor, computer or computing arrangement has adequate processing power to performs the tasks described herein and in the exemplary embodiment is the main processor of the portable device assembly that facilitates the over functionality of the portable communication device 100.

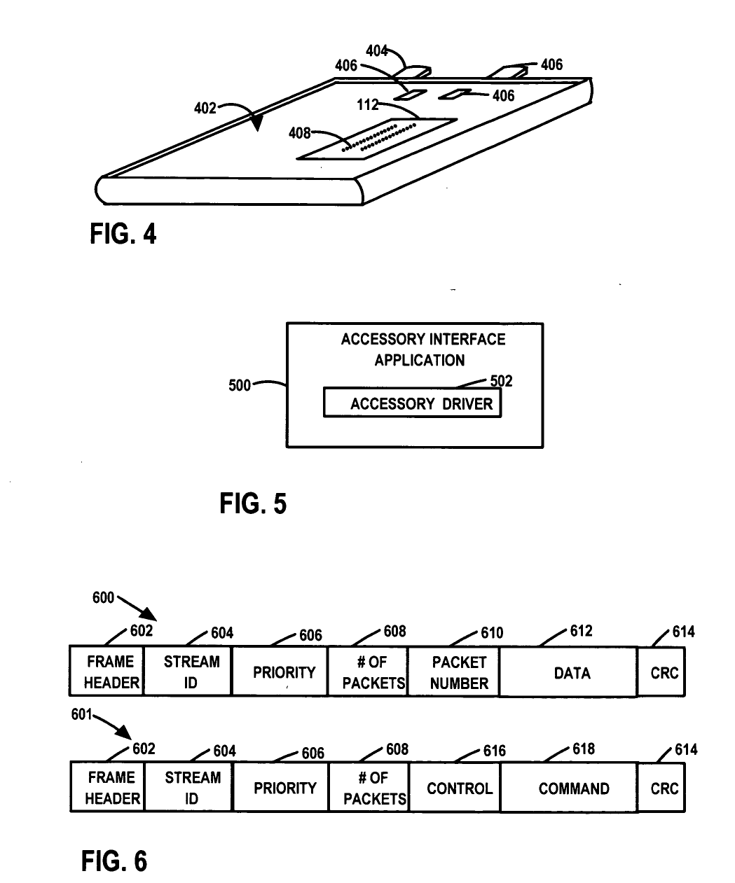

FIG. 3 is an illustration of a perspective view of a portable device assembly 104 and FIG. 4 is an illustration of a perspective view of the accessory module 102 in accordance with the exemplary embodiment of the invention. The portable device assembly 104 may have any of numerous configurations, shapes, or sizes. In the exemplary embodiment, an inside surface 302 of the portable device assembly 104 faces an inside surface 402 of the accessory module 102 when the accessory module is secured to the portable device assembly 104 to form the portable communication device 100. The views in FIG. 3 and FIG. 4 show the portable device assembly 104 and the accessory module 102 with inside surfaces 302, 402 facing up. A securing mechanism allows the accessory module 102 to be removably attached to the portable communication device 100. In the exemplary embodiment, a plurality of securing tabs 404 on the accessory module 102 are received in a plurality of corresponding openings 304 in the portable device assembly 104 to form the securing mechanism. Other types of securing mechanisms may be used depending on the particular design and configuration of the portable communication device 100.

Two battery contacts 306 form electrical connections to the battery terminals 406 when the accessory module 102 is secured to the portable device assembly 104. In the exemplary embodiment, the assembly interface 110 is a mechanical interface that includes 32 electrical contact pads 308 arranged in two rows of sixteen. The electrical contact pads 308 are connected to input and output ports of the processor 122 as well as other components of the device circuitry 108. The assembly interface 110 may have any of several configurations, physical characteristics, or number of connections. As explained above, the assembly interface 110 may be a wireless interface such as an infrared, Bluetooth, or other RF interface. Although a single connection may be adequate for some situations, the assembly interface 110 includes at least seven connections in the exemplary embodiment to support data, control, and device ID sense signals for a particular accessory module. The exemplary pin configuration includes pins for positive and negative transmit and receive signals, signal ground, device identification, and clock signals (i.e. +TXData, −TXData+RXData, −RXData, GND, and CLK. Supply power and ground for the accessory device are obtained from the battery in the exemplary embodiment. In some situations, however, the power signals may be obtained from the portable device assembly 104. The electrical connection pads 308 are arranged to engage spring loaded pins 408 such as pogo pins of the module interface 112 when the accessory module 102 is secured to the portable device assembly 104. The connection pads 308 are connected to input and output ports on the processor 122 or other circuitry within the portable communication device 100 where the ports may operate in accordance with any of numerous interface standards such as general purpose input/output (GPIO) and/or universal asynchronous receiver-transmitter (UART) interfaces, for example. The arrangement of the connectors 408 (pogo pins) is not necessarily the same on each type of accessory module 102 in the exemplary embodiment. For example, the Device ID sense pin may be in the same location on each accessory module but the pins for the +TXData, −TXData+RXData, −RXData signals may be located in different positions on different types of accessory modules 102.

In the exemplary embodiment, signals are transmitted between the accessory device 114 and the device circuitry 108 using a Universal Serial Bus (USB) protocol. Other standard protocols, such as Secure Digital I/O, may also be used. Further, the signals may be transmitted in accordance with non-standard or proprietary protocols in some circumstances. Although parallel protocols may be used, serial protocols provide a higher bandwidth connection with a fewer number of connection lines in most circumstances.

FIG. 5 is a block diagram of an accessory interface application 500 running on the processor 122 in accordance with the exemplary embodiment of the invention. The application 500 is executable software code generates, transmits, receives and deciphers data, control and command signals to control the accessory device 114. The accessory interface application includes at least one accessory driver 502 that enables communication between the accessory interface application 500 and the accessory device 114. Accordingly, the accessory driver 502 includes command, control and data processing information corresponding to a particular accessory device module 102. The accessory driver 502 behaves as a translator between the generalized commands of the accessory interface application and specialized commands required by the accessory module 102. The accessory driver is any code or set of instructions that enables the application 500 to successfully communicate with the accessory module. Examples of suitable accessory drivers include subroutines, plug-in software modules, and applets. In the exemplary embodiment, the accessory interface application is implemented as a Java application and the accessory drivers 502 are Java applets.

The accessory drivers 502 may be loaded into the portable device assembly using any of numerous techniques. Some suitable examples include storing the accessory driver in a non-volatile memory within the portable device assembly during the manufacturing process, when initiated by the user, or automatically in response to a detection that a new accessory device has been connected and is not supported by the current accessory drivers 502. The accessory driver 502 may be loaded through an electrical connector on the portable communication device assembly 104 or through a wireless communication channel.

In the exemplary embodiment, the accessory driver 502 is stored in memory of the accessory module 102 and loaded to the portable device assembly when the assembly module is connected and initialized for the first time. As explained below in further detail, the application 500 determines identifies the accessory module based on data received through the connection interface 120 and determines if the appropriate accessory drive 502 is available. If the accessory driver 502 is not yet loaded, it is transferred from the accessory device memory to the memory of the portable device assembly 104.

FIG. 6 is a block diagram of a data frame 600 and a control frame 601 in accordance with the exemplary embodiment of the invention. As explained above, any of numerous protocols can be used to exchange communication signals between the accessory device and the device circuitry. Accordingly, the exemplary protocol described with reference to FIG. 6 may be modified or replaced with other suitable protocols depending on the particular implementation. Data signals are exchanged over the interface standard 116 using the data frame 600 and control and command signals are exchanged using the control frame 601. The data frame 600 and the control frame 601 each include a frame header 602, stream ID 604, priority identifier 606, packet quantity indicator 608, and a cyclic redundancy check (CRC) 614. A payload within the data frame 600 includes a packet number identifier 610 and data 612. The frame header 602 is a four bit header that indicates the beginning of the frame 600, 601 as well as whether the frame is a control frame 601 or data frame 600.

The stream ID 604 is a four bit identifier that identifies the stream to which the data or control information pertains. Generally, stream IDs allow a set of frames transmitted at different times to be associated with each other to form a single continuous series of data or “stream”. Frames with the same stream ID 604 belong to the same stream. Thus, a single stream can have multiple interleaved series of frame data or control information of the same type. All of the frames with a given stream ID must be of the same frame type. In the exemplary embodiment each stream includes a control plane and a data plane.

The priority indicator 606 is a four bit identifier that indicates priority of the frame and facilitates QOS/LOS priority management. The packet quantity indicator 610 defines the total length of the payload in bytes. The payload frame is a variable length frame in the exemplary embodiment where the total length is indicated. Within the payload packets, a rolling 8-bit packet header is used to allow the application to reassemble packets in the proper sequence where interleaved streams are transmitted. The application running on the portable communication device assembly only needs to request missing packets via a negative acknowledgement in the exemplary embodiment. Accordingly, properly received payload packets are not acknowledged and only missing packets are identified. The CRC 614 is a 16 bit CRC that maximizes frame integrity. The exemplary data frame 600 includes padding bits when needed to complete a frame to the end of byte boundary. Other fields in the data stream may be used in some circumstances.

The control frame 601 may convey a command or response and includes a control field 616 and a command field 618 where the command field may contain a true/false indicator, numeric data, text data or an on/off indicator. The control field 616 indicates a basic function, and the command field 618 includes instructions on how to handle the function. For example, for a LIST control request, the command is to list types or objects. The response would be a LIST control response, and the command field would contain data corresponding to the desired command code sent on the request.

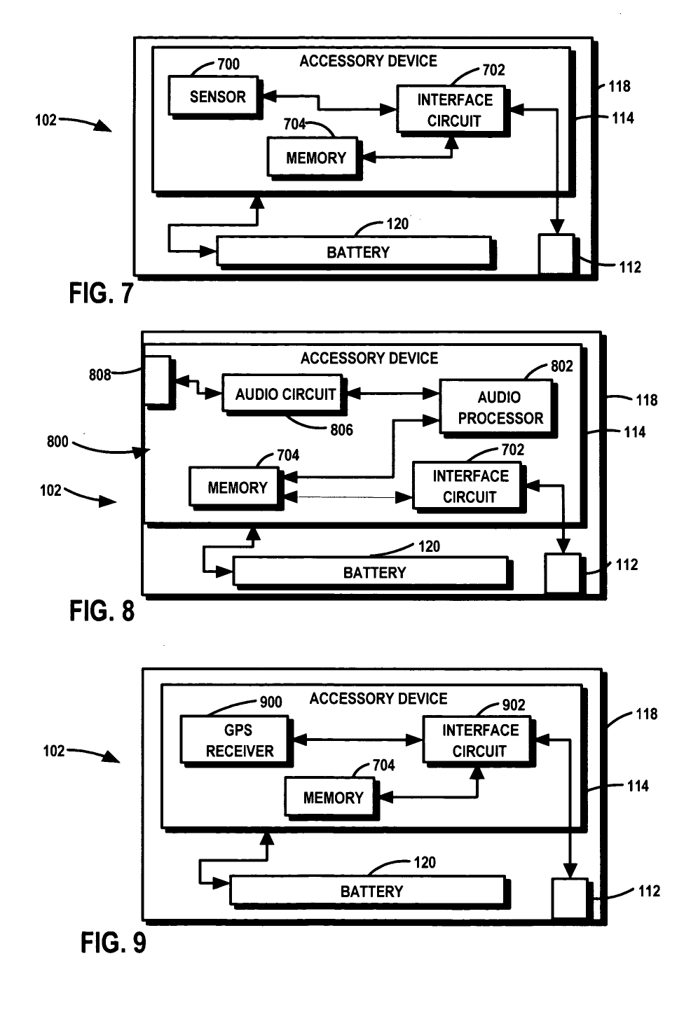

FIG. 7 is a block diagram of the accessory module 102 where the accessory device 114 includes a sensor 700 in accordance with the exemplary embodiment of the invention. The sensor 700 may be any sensing device that converts a physical condition into a signal. Examples of sensors 700 include temperature sensors, radiation sensors, optical sensors, microphones, movement sensors, magnetic sensors, directional sensors such an electronic compass, smoke detectors, mold detectors, and carbon monoxide detectors.

The sensor 700 is connected to an interface circuit 702 that includes any combination of hardware, software and/or firmware for communicating with the device circuitry 108. The interface circuit 702 may be a driver chip such as an integrated circuit (IC) configured to access and communicate with a processor within the device circuitry 108. The interface circuit 302 communicates with the device circuitry 108 in accordance with the interface standard 116 to send and receive commands, control signals, and data. A application running in the portable device assembly sends and receives

During operation of the portable communication device 100, the sensor 700 converts a physical state, condition, or characteristic into an analog or digital representation. The representation is received by the interface circuit 302, processed if necessary, and presented to the device circuitry through the module interface 112.

In the exemplary embodiment, the battery 120 within accessory module 102 provides power to the accessory device 114. The accessory device 114 may include other components, circuits or features. A power supply filter or circuit protection circuit may be included in some circumstances, for example.

When the accessory module 102 is secured to the portable device assembly, the accessory interface application performs an initialization procedure. After the power the attachment of the accessory module is detected, the clock signal is placed active. The interface circuit in the accessory module synchronizes to the processor 124 using the clock signal and sends a command frame 691 with a device identifier in the control field 616 and device capability descriptor in the command field 618. Based on the information received, the accessory interface application confirms that the appropriate driver is loaded or loads the appropriate accessory driver 502. The clock signal is deactivated to put the accessory device into sleep mode. When the accessory device is to be used, the clock signals is activate and control frames 601 are transmitted to accessory device to control the device. Sensed data is processed and formed into the data packets and frames and transmitted to the accessory interface application through the connection interface 120. The accessory interface application receives and deciphers the data and forwards it to the appropriate other application running on the processor 124.

FIG. 8 is a block diagram of the accessory module 102 where the accessory device 114 includes a music player 800 in accordance with the exemplary embodiment of the invention. The accessory module 102 with the music player 800 is initialized as described above with reference to FIG. 7. The music player 800 includes at least an audio processor 802 configured to convert stored audio files into an analog signal. In the exemplary embodiment, the music player 800 includes the audio processor 802, a memory device 804, and an audio circuit 804. The audio processor 802 is any combination of hardware, software, and/or firmware configured to convert and audio file such an MP3 or WMA file into an analog audio signal. The audio signal is amplified and otherwise processed by the audio circuit before it is presented at an audio jack 808. Headphones or external speakers may be plugged into the audio jack 808. In some circumstances, the audio signals can be routed back to the portable device assembly and presented through a speaker or an audio jack on the portable device assembly.

FIG. 9 is a block diagram of the accessory module 102 where the accessory device 114 includes global positioning satellite (GPS) receiver 900 in accordance with the exemplary embodiment of the invention. After the accessory module 102 is secured to the portable device assembly, the accessory device 102 is initialized as described above with reference to FIG. 7. The GPS receiver 900 processes signals received from satellites to derive location information. The location information is formed data packets within data frames and transferred to the accessory interface application through the interface connection 120. The accessory interface application deciphers the frames and provides the location information to the appropriate applications running on the processor 124.

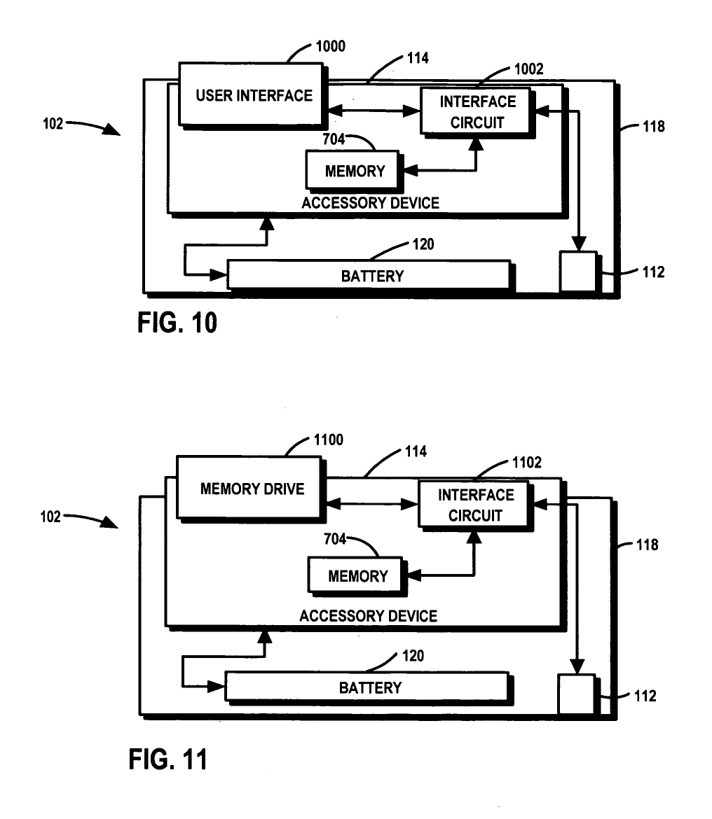

FIG. 10 is a block diagram of the accessory module 102 where the accessory device 114 includes a user interface 1000. After the accessory module 102 is secured to the portable device assembly, the accessory device 102 is initialized as described above with reference to FIG. 7. The user interface may include an output device such as a visual display or speaker and/or may include an input device such as optical sensor, fingerprint reader, keypad, keyboard, joystick, touch pad, or microphone. In the exemplary embodiment, the signals exchanged through the connection interface 120 may include output data for presenting through an output device or may include input data entered by the user into an input device depending on the user interface.

FIG. 11 is a block diagram of the accessory module 102 where the accessory device 114 includes an external memory drive 1100. After the accessory module 102 is secured to the portable device assembly, the accessory device 102 is initialized as described above with reference to FIG. 7. The memory drive 1100 is configured to read and write to an external memory medium such as, for example, a memory card, disk, or flash memory device. Accordingly, the files and data within the portable device assembly may be transferred to or retrieved from the external memory medium.

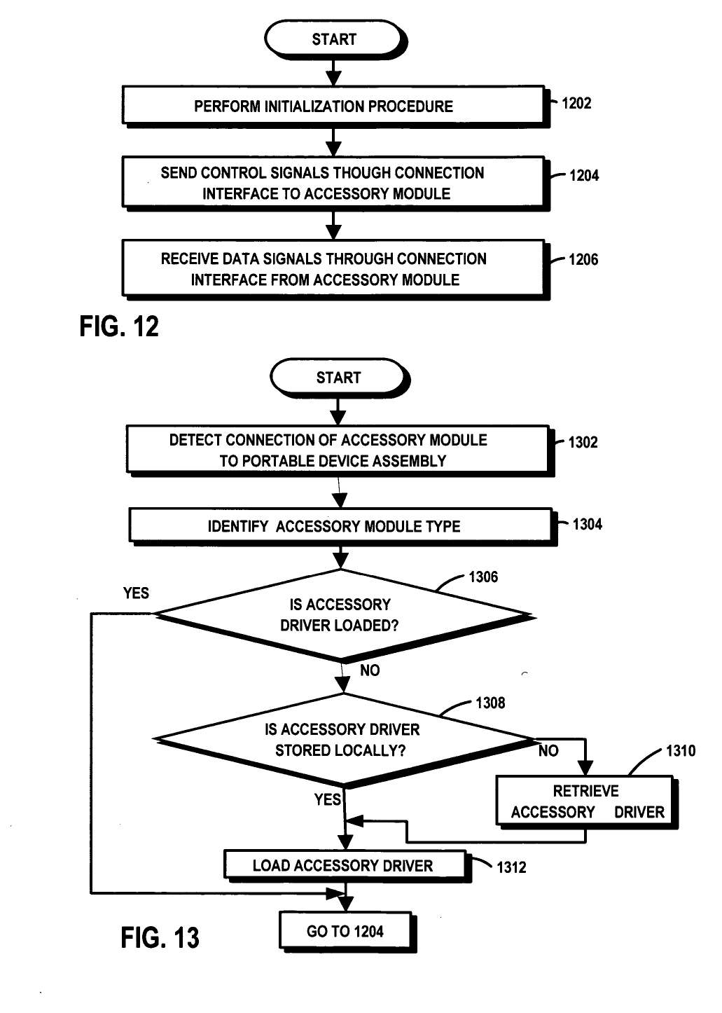

FIG. 12 is a flow chart of a method for managing the accessory module 102 performed in the portable device assembly in accordance with the exemplary embodiment. Steps 1202, 1204 and 1206 may be performed in an order other than presented in FIG. 12. For example, step 1204 may be performed after step 1206 or simultaneously with step 1206.

At step 1202, an initialization procedure is performed. In the exemplary embodiment, the communication is initiated between the accessory application, the accessory module type is identified and the appropriate accessory driver is loaded or verified. An exemplary technique for performing step 1202 is discussed below with reference to FIG. 13.

At step 1204, control signals are transmitted through the connection interface to the accessory module. In the exemplary embodiment, one or more control frames are generated and transmitted in accordance with the interface standard through the connection made between the module interface and the assembly interface.

At step 1206, data signals are exchanged with the accessory module through the connection interface. In the exemplary embodiment, the one or more data frames 600 are received from the accessory module where the accessory device comprises a sensor or input device, or other device that provides data to the accessory module. Where the accessory device is an output device such as visual display or speaker, one or more data frames are transmitted through the connection interface to the interface circuit of the accessory module.

FIG. 13 is a flow chart of a method for performing an initialization procedure in accordance with the exemplary embodiment of the invention. Accordingly steps 1302-1312 provide an exemplary method for performing step 1202 of FIG. 2. The method is performed by executing software code on the processor 124 in the exemplary embodiment.

At step 1302, a connection of the accessory module to the portable device assembly is detected. In the exemplary embodiment, a clock signal is provided to the CLK pin of the accessory module in response to the non-detection of a valid battery identifier through battery ID pin. The clock signal is cases the interface circuit in the accessory module to initialize and transmit a command frame including a device identifier (Device ID). When the device ID is received, the accessory application determines that a valid accessory module is connected to the portable device assembly.

At step 1304, the accessory module type is identified. In the exemplary embodiment, the Device ID is used to determine the class of devices or specific device that is connected to the portable device assembly. The device ID is also used to identify the accessory driver that corresponds to the accessory module.

At step 1306, it is determined whether the accessory driver is loaded. If the accessory driver is loaded, the method continues at step 1204. Otherwise, the procedure continues at step 1308 where it is determined whether the accessory driver is stored locally.

At step 1308, the memory within the portable device assembly is searched for the accessory driver identified in step 1304. If the accessory driver is found, the accessory driver is loaded at step 1312. If the accessory driver is not stored locally, the method continues at step 1310.

At step 1310, the accessory driver is retrieved. In the exemplary embodiment, the accessory driver is retrieved from the memory 704 of the accessory module. A load driver command frame is transmitted to the interface circuit and the accessory driver is downloaded from the memory 704 to the memory of the portable device assembly using data frames. In some circumstances, the accessory driver may be downloaded from a personal computer or other external device using a cable or wireless connection. Also, the accessory device may be downloaded through the wireless channel provide by the communication system in other circumstances.

At step 1312, the accessory driver is loaded in to the accessory interface application 500. As described above, the accessory interface application is java application and the accessory drivers are java applets in the exemplary embodiment. Other types of drivers and interface applications may be used.

Therefore, in the exemplary embodiment, a portable communication device system includes a portable communication device assembly 104 and a plurality of accessory modules 102, 302 that include different accessories and perform different functions. The user selects an accessory module with the appropriate functionality to expand the capabilities of the portable communication device. Data and control signals are exchanged over an interface connection between the accessory module and the portable device assembly in accordance with the interface standard.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A method for managing communications in a portable device assembly, the method comprising:
receiving data from an accessory module detachably connected to the portable device assembly, the accessory module comprising an accessory device and a battery for providing power to a portable communication device, the portable communication device formed when the accessory module is connected to the portable device assembly.

2. The method of claim 1, where the receiving data comprises:
receiving data packets comprising the data through an interface connection between the accessory module and portable device assembly.

3. The method of claim 2, where the receiving data packets comprises:
receiving data frames comprising the data packets.

4. The method of claim 1, further comprising:
performing an initialization procedure when the accessory module is connected to the portable device assembly.

5. The method of claim 4 wherein the initialization procedure comprises:
detecting connection of the accessory module to the portable device assembly;
receiving a device identifier from the accessory module; and
identifying an accessory module type based on the device identifier.

6. The method of claim 5, wherein the initialization procedure further comprises:
retrieving an accessory driver from the accessory module.

7. The method of claim 1, wherein receiving the data comprises receiving sensor data captured by a sensor in the accessory module.

8. The method of claim 7, wherein receiving the data comprises receiving image data captured by a camera in the accessory module.

9. The method of claim 7, wherein the sensor is selected from the group consisting of optical sensors, radiation sensors, movement sensors, airborne particle sensors, magnetic sensors, directional sensors, smoke detectors, mold detectors, carbon monoxide detectors and any suitable combination of the foregoing.

10. The method of claim 1, wherein the receiving the data comprises receiving audio data from a music player in the accessory module.

11. The method of claim 1, wherein the receiving the data comprises receiving location information from a global positioning satellite (GPS) receiver in the accessory module.

12. The method of claim 1, wherein the receiving the data comprises receiving stored data stored in memory device in the accessory module.

13. The method of claim 12, wherein memory device comprises a memory integrated circuit device.

14. The method of claim 12, wherein memory device comprises a hard drive memory device.

15. A method for managing communications in a portable device assembly, the method comprising:
transmitting control signals to an accessory module detachably connected to the portable device assembly and comprising an accessory device and a battery for providing power to a portable communication device formed when the accessory module is connected to the portable device assembly.

16. The method of claim 15, wherein the transmitting control signals comprises transmitting control signals to a user interface of the accessory module.

17. The method of claim 16, wherein the transmitting control signals comprises transmitting control signals to a visual display of the accessory module.

18. A method for managing communications in a portable device assembly, the method comprising:
receiving an device identifier from an accessory module detachably connected to the portable device assembly and comprising an accessory device and a battery for providing power to a portable communication device formed when the accessory module is connected to the portable device assembly;
retrieving an accessory driver from a module memory within the accessory module;
transmitting control signals to the accessory module; and
receiving data from the accessory module.

19. The method of claim 18, wherein the retrieving is in response to a determination the accessory device is not loaded in the portable device assembly.

20. The method of claim 19, wherein the receiving data comprises receiving sensor data captured by a sensor of the accessory module.
